(19) United States
(12) Patent Application Publication
(10) Pub. No.: US 2023/0413164 A1
(43) Pub. Date: Dec. 21, 2023

(54) ACCUMULATION METHODS FOR SYSTEM INFORMATION (SI) WINDOWS AND APPARATUS THEREOF

(71) Applicant: MediaTek Singapore Pte. Ltd., Singapore (SG)

(72) Inventors: Wen TANG, Beijing (CN); Gilles CHARBIT, Cambridge (GB); Yaohua CAI, Shanghai (CN)

(21) Appl. No.: 18/336,330

(22) Filed: Jun. 16, 2023

(30) Foreign Application Priority Data
Jun. 17, 2022 (WO) PCT/CN2022/099522
Jun. 13, 2023 (CN) 202310694180.7

(51) Int. Cl. H04W 48/12; H04W 4/70

(52) U.S. Cl. CPC H04W 48/12; H04W 4/70

(57) ABSTRACT

Accumulation methods for system information (SI) windows are provided. The accumulation method for SI windows may include the following steps. The transceiver of an apparatus may receive an indication from a network node. The processor of the apparatus may determine a set of SI windows in a modification period based on the indication. The processor may perform an accumulation over the SI windows in the set of SI windows.

### CROSS REFERENCE TO RELATED APPLICATIONS

This application claims the benefits of PCT Application No. PCT/CN2022/099522 filed on Jun. 17, 2022 and CN Patent Application 202310694180.7 filed on Jun. 13, 2023, the entirety of which is incorporated by reference herein.

### BACKGROUND OF THE INVENTION

### Field of the Invention

The invention generally relates to system information block (SIB) accumulation technology, and more particularly, to an SIB accumulation technology in which an indication is used to indicate the SIB accumulation within a set of SI windows in the same modification period.

### Description of the Related Art

In internet of things (IoT) systems, both narrowband internet of things (NB-IoT) technology and enhanced machine-type communication (eMTC) technology may allow system information block (SIB) repetitions within a system information (SI) window. Additionally, the user equipment (UE) may possibly accumulate SIBs across multiple SI windows if they are needed for decoding, considering coverage enhancement. When the SIB updates between different modification periods, the evolved node B (eNB) may transmit a “Direct Indication information” with “systemInfoModification” field to notify the UE about SIB updates and to activate new modification period.

However, there are SIBs (e.g., Non-terrestrial networks (NTN) SIBs) that can be updated in the same modification period without the need for an extra indication to the UE. Therefore, the UE cannot know that the parameters of the SIB are updated in the same modification period. This may cause the UE to over-accumulate SI windows and not to decode SIBs successfully.

Therefore, how to ensure that the UE can decode SIBs within the SI windows of a modification period successfully when the parameters of said SIB are updated in the same modification period is a topic that is worthy of discussion.

### BRIEF SUMMARY OF THE INVENTION

Accumulation methods for system information (SI) windows and an apparatus are provided to overcome the problems mentioned above.

An embodiment of the invention provides an accumulation method for system information (SI) windows. The accumulation method for SI windows may comprise following steps. A transceiver of an apparatus may receive an indication from a network node. A processor of the apparatus may determine a set of SI windows in a modification period based on the indication. The processor may perform an accumulation over the SI windows in the set.

In some embodiments of the invention, in the accumulation method, the apparatus may receive the indication through a system information block 1 (SIB1) or a radio resource control (RRC) signaling.

In some embodiments of the invention, in the accumulation method, in response to the indication comprising one bit, the apparatus may determine the number of SI windows in the set for enhanced machine-type communication (eMTC) based on the first default value and the periodicity of the SI window and determine the number of SI windows in the set for narrowband internet of things (NB-IoT) based on the second default value and the periodicity of the SI window in response to the bit being the first value; and the apparatus may determine the number of SI windows in the set for eMTC based on the third default value and the periodicity of the SI window and determine the number of SI windows in the set for NB-IoT based on the fourth default value and the periodicity of the SI window in response to the bit being the second value.

In some embodiments of the invention, in the accumulation method, in response to the indication comprising a plurality of bits, the apparatus may determine the number of SI windows in the set based on the plurality of bits and a mapping rule. The mapping rule may be determined based on a mapping table or a predefined equation, wherein the mapping table may be configured or predefined.

In some embodiments of the invention, in the accumulation method, when the indication comprises a first set of bits and a second set of bits, the apparatus may determine the number of SI windows in the set based on the first set of bits, and determine the start position of the set of SI windows in the modification period based on the second set of bits.

In some embodiments of the invention, in the accumulation method, the apparatus may determine a start position of the set of SI windows in the modification period based on the first window in the modification period.

In some embodiment of the invention, in the accumulation method, the apparatus may receive the indication through a paging, with a Direct Indication information. When the indication in the Direct Indication information is default or is not configured, the apparatus may perform a SIB accumulation across the SI windows before the Direct Indication information and after the Direct Indication information within the modification period. In addition, the indication may use a bit to indicate a SI update information within the modification period. In response to the bit corresponding to a first value, the apparatus may perform the accumulation over the SI windows which are before the paging in the modification period, and in response to the bit corresponding to a second value, the apparatus may perform the accumulation over the SI windows which are before the paging and the SI windows which are after the paging in the modification period. And the indication may be a new indication field in the Direct Indication information. The new filed may use spare bits in the Direct Indication information which may be transmitted on narrowband physical downlink control channel (NPDCCH) or Machine Type Communication (MTC) PDCCH (MPDCCH) through a paging radio network temporary identifier (P-RNTI).

In some embodiments of the invention, in the accumulation method, the apparatus may decode the system information block (SIB) in the set of SI windows, wherein the SIB comprises updated information.

An embodiment of the invention provides an apparatus. The apparatus may comprise a transceiver and a processor. The transceiver may receive an indication from a network node. The processor is coupled to the transceiver. The processor may determine a set of SI windows in a modification period based on the indication, and may perform an accumulation over the SI windows in the set.

An embodiment of the invention provides an accumulation method for system information (SI) windows. The accumulation method for SI windows may comprise following steps. A processor of a network node may determine a set of SI windows in a modification period, wherein an accumulation is able to be performed over the SI windows in the set. A transceiver of the network node may transmit an indication associated with the set of SI windows to a user equipment (UE) through a system information block 1 (SIB1), a radio resource control (RRC) signaling or a paging.

Other aspects and features of the invention will become apparent to those with ordinary skill in the art upon review of the following descriptions of specific embodiments of the accumulation methods for SI windows and apparatus.

### BRIEF DESCRIPTION OF THE DRAWINGS

The invention will become more fully understood by referring to the following detailed description with reference to the accompanying drawings, wherein:

FIG. 1 is a block diagram of a wireless communications system according to an embodiment of the invention.

FIG. 2 is a schematic diagram illustrating a set of SI windows for SIB accumulation in a modification period according to an embodiment of the invention.

FIG. 3 is a schematic diagram illustrating a set of SI windows for SIB accumulation in a modification period according to another embodiment of the invention.

FIG. 4 is a schematic diagram illustrating a set of SI windows for SIB accumulation in a modification period according to another embodiment of the invention.

FIG. 5 is an accumulation method for SI windows according to an embodiment of the invention.

FIG. 6 is an accumulation method for SI windows according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

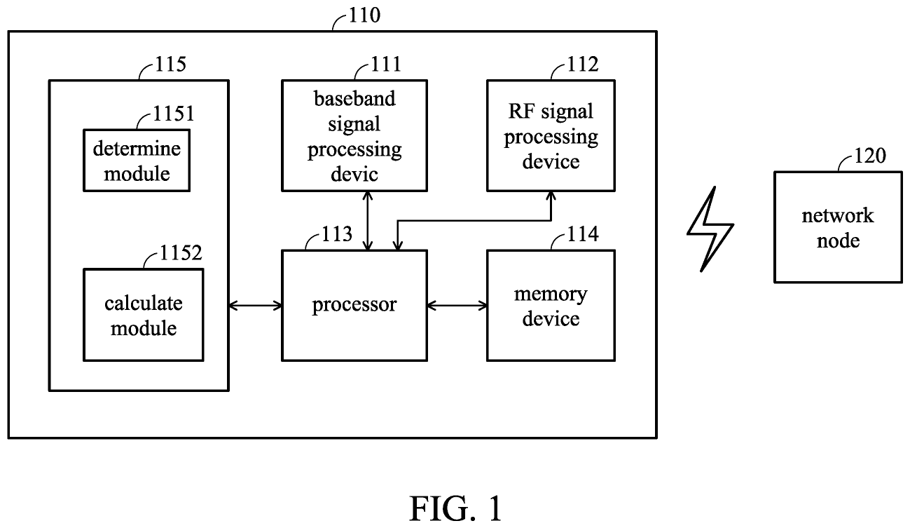

FIG. 1 is a block diagram of a wireless communications system according to an embodiment of the invention. As shown in FIG. 1, the wireless communications system may comprise user equipment (UE) 110 and a network node 120. It should be noted that in order to clarify the concept of the invention, FIG. 1 presents a simplified block diagram in which only the elements relevant to the invention are shown. However, the invention should not be limited to what is shown in FIG. 1.

In the embodiments, the network node 120 may be a base station, a gNodeB (gNB), a NodeB (NB) an eNodeB (eNB), an access point, an access terminal, but the invention should not be limited thereto. In the embodiments, the UE 110 may communicate with the network node 120 through the fourth generation (4G) communication technology, fifth generation (5G) communication technology, but the invention should not be limited thereto. The UE 110 may communicate with the network node 120 through a low power wide area network (LPWAN) technology, e.g., narrowband internet of things (NB-IoT), enhanced machine-type communication (eMTC), and so on.

As shown in FIG. 1, the UE 110 may comprise at least a baseband signal processing device 111, a radio frequency (RF) signal processing device 112, a processor 113, a memory device 114, and function modules and circuits 115. The network node 120 may comprise similar devices as UE 110.

In the embodiments of the invention, the UE 110 may be a smartphone, Personal Data Assistant (PDA), pager, laptop computer, desktop computer, wireless handset, or any computing device that includes a wireless communications interface.

The RF signal processing device 112 may be a transceiver. The RF signal processing device 112 may comprise a plurality of antennas to receive or transmit RF signals. The RF signal processing device 112 may receive RF signals via the antennas and process the received RF signals to convert the received RF signals to baseband signals to be processed by the baseband signal processing device 111, or receive baseband signals from the baseband signal processing device 211 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, analog-to-digital converter (ADC)/digital-to-analog converter (DAC), etc.

The baseband signal processing device 111 may further process the baseband signals to obtain information or data transmitted by the peer communications apparatus. The baseband signal processing device 111 may also comprise a plurality of hardware elements to perform baseband signal processing.

The processor 113 may control the operations of the baseband signal processing device 111, the RF signal processing device 112, the memory device 114 and the function modules and circuits 115. According to an embodiment of the invention, the processor 113 may also be arranged to execute the program codes of the software module(s) of the corresponding baseband signal processing device 111, the RF signal processing device 112 and the function modules and circuits 115. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software modules.

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof.

According to an embodiment of the invention, the RF signal processing device 112 and the baseband signal processing device 111 may collectively be regarded as a radio module capable of communicating with a wireless network to provide wireless communications services in compliance with a predetermined Radio Access Technology (RAT). Note that, in some embodiments of the invention, the UE 110 may be extended further to comprise more than one antenna and/or more than one radio module, and the invention should not be limited to what is shown in FIG. 1.

The function modules and circuits 115 may comprise a determine module 1151 and a calculate module 1152. The processor 113 may execute different modules or circuits in the function modules and circuits 115 to perform embodiments of the present invention. In the embodiment of the invention, the determine module 1151 may determine a set of SI windows in a modification period based on an indication from the network 120. The calculate module 1152 may an accumulation over the SI windows in the set.

In the embodiments of the invention, the UE 110 may receive an indication from the network node 120. The UE 110 may determine a set of system information (SI) windows in a modification period (e.g., a broadcast control channel (BCCH) modification period) based on the indication. Then, the UE 110 may perform an accumulation over (or across) the SI windows in the set. That is, the UE 110 may accumulate the system information blocks (SIBs) within the SI windows in the set in the modification period. The UE 110 may decode the SIBs in the set of SI windows in the modification period, and some SIBs in the modification period may comprise updated information based on the indication. Details for the indication for SIB accumulation in the same modification period are illustrated below.

According to an embodiment of the invention, the UE 110 may receive the indication from the network node 120 through a system information block 1 (SIB1) or a radio resource control (RRC) signaling.

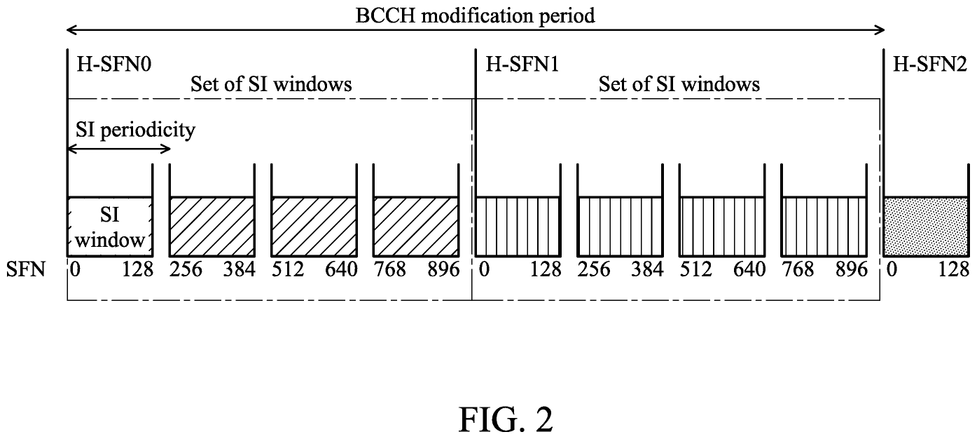

In an aspect of the embodiment, the indication may comprise one bit, i.e., the indication may be carried on SIB1 or RRC signaling with 1 bit. When the bit is the first value (e.g., 0), the UE 110 may determine the number of SI windows in the set for enhanced machine-type communication (eMTC) based on the first default value and the periodicity of the SI window and determine the number of SI windows in the set for narrowband internet of things (NB-IoT) based on the second default value and the periodicity of the SI window. For example, when the bit is 0, the UE 110 may determine the number of SI windows in the set for eMTC using a formula, [512/periodicity of the SI window], and determine the number of SI windows in the set for NB-IoT using another formula, [1024/periodicity of the SI window], wherein 512 is the first default value and the 1024 is the second default value. In addition, when the bit is the second value (e.g., 1), the UE 110 may determine the number of SI windows in the set for eMTC based on the third default value and the periodicity of the SI window and determine the number of SI windows in the set for NB-IoT based on the fourth default value and the periodicity of the SI window. For example, when the bit is 1, the UE 110 may determine the number of SI windows in the set for eMTC using a formula, [1024/periodicity of the SI window], and determine the number of SI windows in the set for NB-IoT using another formula, [2048/periodicity of the SI window], wherein 1024 is the third default value and the 2048 is the fourth default value. The first default value, second default value, the third default value and the fourth default value may be the multiple of the periodicity of the SI window. The first default value, second default value, the third default value and the fourth default value may be pre-set by the network node 120 and provided to the UE 110 through a RRC configuration. FIG. 2 is used to illustrate an example based on the aspect.

FIG.2 is a schematic diagram illustrating a set of SI windows for SIB accumulation in a modification period according to an embodiment of the invention. As shown in FIG. 2, if the periodicity of the SI window is 256, when the bit is 1, the UE 110 may determine the number of SI windows in the set for eMTC using a formula, [1024/periodicity of the SI window], i.e., the number of SI windows in the set is 4 (1024/256). Therefore, as shown in FIG. 2, in a BCCH modification period, a set of SI windows may comprise 4 SI windows. The UE 110 may accumulate SIBs within the 4 SI windows in a set of SI windows. That is, the SI windows in the same SI window set in the BCCH modification period may have the same parameters. The SIBs in different sets of SI windows in the BCCH modification period cannot be accumulated. In other words, the parameters for SIB may be changed or updated in different sets of SI windows in the BCCH modification period, i.e., the parameters for SIB may be changed or updated in next set of SI windows.

Furthermore, in the aspect, the first SI window in the BCCH modification period may be regarded as a start position of the set of SI windows. That is, the UE 110 may know that the accumulation for the set of SI windows can be performed from the start position of the set of SI windows. As shown in FIG. 2, the UE 110 may perform the accumulation for a set of SI windows from the first SI window of the set of SI windows (i.e., the first SI window of the BCCH modification period), and perform another accumulation for next set of SI windows from the first SI window of the next set of SI windows.

In another aspect of the embodiment, the indication may comprise a plurality of bits, i.e., the indication may be carried on SIB1 or RRC signaling with a plurality of bits. The UE 110 may determine the number of SI windows in the set of SI windows based on the plurality of bits and a mapping rule. The mapping rule may be determined based on a mapping table or a predefined equation, wherein the mapping table may be configured or predefined. Then, the UE 110 may perform SIB accumulation over the SI windows in the set of SI windows. Different bitmap of indication may correspond to different number of SI windows in the set of SI windows. For example, if the indication comprises 2 bits, when the bitmap is 00, the number of SI windows in the set may be 1, when the bitmap is 01, the number of SI windows in the set may be 2, when the bitmap is 10, the number of SI windows in the set may be 3, and when the bitmap is 11, the number of SI windows in the set may be 4, but the invention should not be limited thereto. Taking FIG. 2 as an example, a set of SI windows comprise 4 SI windows. Therefore, the bitmap may be 11. In an embodiment, the settings of the plurality of bits may be configured based on a mapping rule. The mapping rule may be N=int(X)+1, where N=the number of SI windows in the set and X=bitmap. As the above example, when X=00, N=1; when X=01, N=2; when X=10, N=3; and when X=11, N=4. The settings of the plurality of bits may be recorded in a table (e.g., Table 1). In another embodiment, the UE 110 may determine the number of SI windows in the set of SI windows based on the information stored in a mapping table. The mapping table may be configured by network or predefined.

TABLE 1

| X | N |
|---|---|
| 00 | 1 |
| 01 | 2 |
| 10 | 3 |
| 11 | 4 |

Furthermore, in the aspect, the first SI window in the BCCH modification period may also be regarded as a start position of the set of SI windows. That is, the UE 110 ay know the accumulation for the set of SI windows can be performed from the start position of the set of SI windows. As shown in FIG. 2, the UE 110 may perform the accumulation for a set of SI windows from the first SI window of the set of SI windows (i.e., the first SI window of the BCCH modification period), and perform another accumulation for next set of SI windows from the first SI window of the next set of SI windows.

In another aspect of the embodiment, the indication may comprise a first set of bits and a second set of bits. The UE 110 may determine the number of SI windows in the set based on the first set of bits and determine a start position of the set of SI windows in the modification period based on the second set of bits. Then, the UE 110 may perform SIB accumulation over the SI windows in the set of SI windows from the start position. Different bitmap of the first set of bits may correspond to different number of SI windows in the set of SI windows. For example, if the first set of bits comprises 2 bits, when the bitmap is 00, the number of SI windows in the set of SI windows may be 1, when the bitmap is 01, the number of SI windows in the set of SI windows may be 2, when the bitmap is 10, the number of SI windows in the set of SI windows may be 3, and when the bitmap is 11, the number of SI windows in the set of SI windows may be 4, but the invention should not be limited thereto. In an embodiment, the settings of the plurality of bits may be configured based on a mapping rule. The mapping rule may be N=int (X+1), where N=the number of SI windows in the set of SI windows and X=bitmap. As the above example, when X=00, N=1; when X=01, N=2; when X=10, N=3; and when X=11, N=4. The settings of the plurality of bits may be recorded in a table (e.g., Table 1). In another embodiment, the UE 110 may determine the number of SI windows in the set of SI windows based on the information stored in a mapping table. The mapping table may be configured by network or predefined

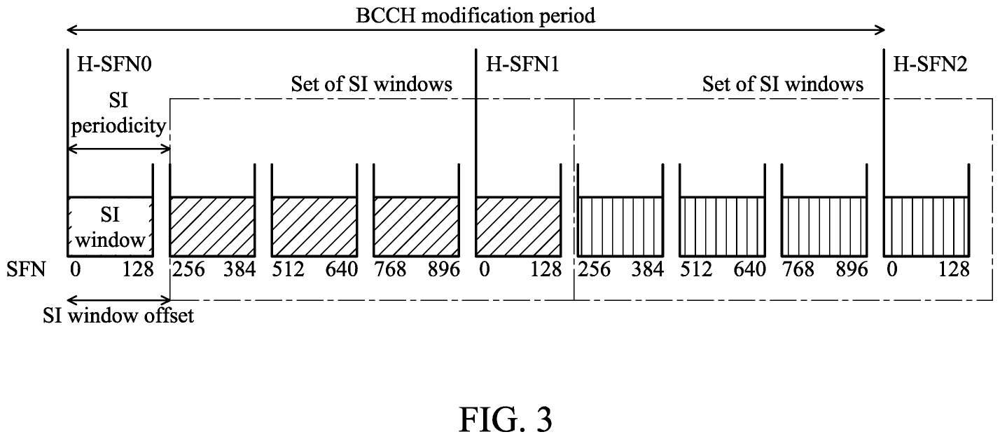

Furthermore, in the aspect, the first SI window in the set may be regarded as a start position of the set of SI windows and the start position of the first SI window is determined based on the second set of bits. That is, the UE 110 may determine start position of the set of SI windows based on the second set of bits, and know the accumulation for the set of SI windows can be performed from the start position. For example, if the second set of bits comprises 2 bits, when the bitmap is 00, the SI window offset may comprise 1 SI periodicity, when the bitmap is 01, the SI window offset may comprise 2 SI periodicities, when the bitmap is 10, the SI window offset may comprise 3 SI periodicities, and when the bitmap is 11, the SI window offset may comprise 4 SI periodicities, but the invention should not be limited thereto. The SI window after the SI window offset will be regarded as the first SI window in the first set of SI windows in the modification period. In addition, in the aspect, the parameters for SIBs of SI windows during the SI window offset in the modification period can be changed or updated. FIG. 3 is used to illustrate an example based on the aspect.

FIG. 3 is a schematic diagram illustrating a set of SI windows for SIB accumulation in a modification period according to another embodiment of the invention. As shown in FIG. 3, if the first set of bits comprises 2 bits and second set of bits comprises 2 bits, when bitmap of first set of bits is 11 and bitmap of second set of bits is 00, the number of SI windows in the set may be 4 and the SI window offset may be 1. Therefore, the UE 110 may determine the start position of the first set of SI windows is the SI window after the SI window offset. Then, the UE 110 may perform the SIB accumulation over the 4 SI windows of the first set of SI windows from the start position (i.e., the second SI window of the BCCH modification period) of the first set of SI windows, and perform the accumulation for next set of SI windows from the first SI window of the next set of SI windows.

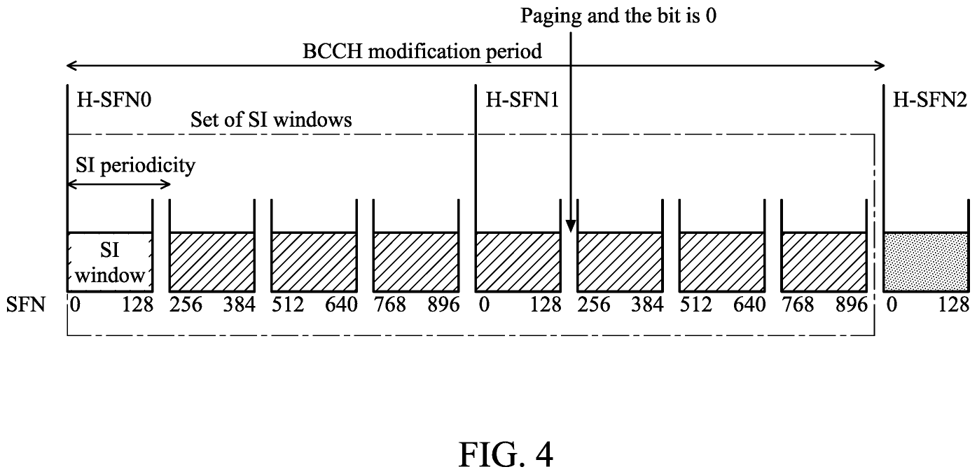

According to another embodiment of the invention, the UE 110 may receive the indication from the network node 120 through a paging (e.g., paging “Direct Indication Information”). In the embodiment, the indication may be used one bit to indicate SI update information within the modification period (i.e., indicate whether the SIBs in the modification period need to be updated or changed, but the update or change does not involve with the modification period). For example, if the indication is 1 bit, in response to the new indication field corresponding to the first value (e.g., 1), the UE 110 may perform the accumulation over the SI windows which are before the paging in the modification period (i.e., after the paging, the SIBs within SI windows may be updated and changed in the modification period); and in response to the indication corresponding to the second value (e.g., 0), the UE 110 may perform the accumulation over the SI windows which are before the paging and the SI windows which are after the paging in the modification period (i.e., the SIBs within SI windows do not need to be updated and changed in the modification period). In an embodiment, a new indication field (i.e., the indication is the new indication field) may be added in the paging “Direct Indication Information”. In another embodiment, the new indication field may use the spare bits in the paging “Direct Indication Information” which is transmitted on narrowband physical downlink control channel (NPDCCH) or Machine Type Communication (MTC) PDCCH (MPDCCH) through a paging radio network temporary identifier (P-RNTI). FIG. 4 is used to illustrate an example based on the aspect. In addition, in an embodiment, when the indication in the paging is default or not configured in the Direct Indication information, the UE may perform the SIB accumulation across SI windows before the Direct Indication information and after the Direct Indication information within the modification period.

FIG. 4 is a schematic diagram illustrating a set of SI windows for SIB accumulation in a modification period according to another embodiment of the invention. As shown in FIG. 4, when the UE 110 receives the paging “Direct Indication Information” with the new indication field from the network node 120, and the value of new indication field is 0, the UE 110 may perform the accumulation over the SI windows which are before the paging and the SI windows which are after the paging in the modification period.

In the embodiments of the invention, the modification period may comprise two hyper-system frame number (H-SFN). As shown, in FIG. 2-FIG. 4, the modification period may comprise H-SFN0+H-SFN1.

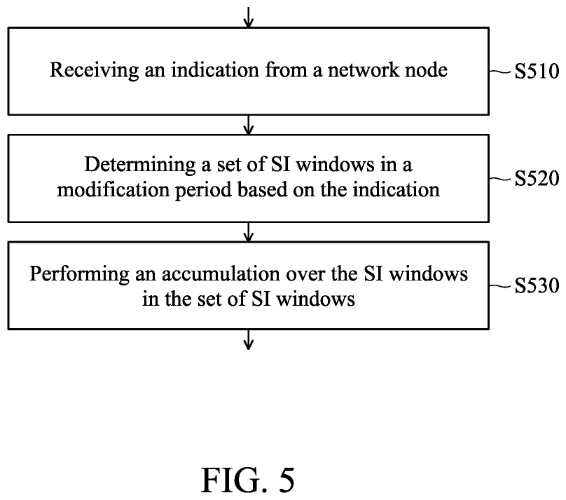

FIG. 5 is a flow chart illustrating an accumulation method for system information (SI) windows according to an embodiment of the invention. The accumulation method can be applied to the UE 110 of the wireless communications system. As shown in FIG. 5, in step S510, the UE 110 may receive an indication from the network node 120.

In step S520, the UE 110 may determine a set of SI windows in a modification period based on the indication.

In step S530, the UE 110 may perform an accumulation over the SI windows in the set of SI windows.

In an embodiment of the invention, in the accumulation method, the UE 110 may receive the indication through a system information block 1 (SIB1) or a radio resource control (RRC) signaling.

In an embodiment of the invention, in the accumulation method, in response to the indication comprising one bit, the UE 110 may determine the number of the SI windows in the set of SI windows for enhanced machine-type communication (eMTC) based on the first default value and the periodicity of the SI window and determine the number of the SI windows in the set of SI windows for narrowband internet of things (NB-IoT) based on the second default value and the periodicity of the SI window in response to the bit being the first value; and the UE 110 may determine the number of the SI windows in the set of SI windows for eMTC based on the third default value and the periodicity of the SI window and determine the number of the SI windows in the set of SI windows for NB -IoT based on the fourth default value and the periodicity of the SI window in response to the bit being the second value.

In an embodiment of the invention, in the accumulation method, in response to the indication comprising a plurality of bits, the UE 110 may determine the number of the SI windows in the set of SI windows based on the plurality of bits and a mapping rule. The mapping rule may be determined based on a mapping table or a predefined equation, wherein the mapping table may be configured or predefined.

In an embodiment of the invention, in the accumulation method, in response to the indication comprising a first set of bits and a second set of bits, the UE 110 may determine the number of the SI windows in the set of SI windows based on the first set of bits, and determine a start position of the set of SI windows in the modification period based on the second set of bits.

In an embodiment of the invention, in the accumulation method, the UE 110 may determine a start position of the set of SI windows in the modification period based on a first window of the modification period.

In an embodiment of the invention, in the accumulation method, the UE 110 may receive the indication through a paging, with a Direct Indication information, which may be transmitted on narrowband physical downlink control channel (NPDCCH) or Machine Type Communication (MTC) PDCCH (MPDCCH) through a paging radio network temporary identifier (P-RNTI). The indication may use a bit to indicate a SI update information within the modification period. In response to the bit corresponding to a first value, the UE 110 may perform the accumulation over the SI windows which are before the paging in the modification period, and in response to the bit corresponding to a second value, the UE 110 may perform the accumulation over the SI windows which are before the paging and the SI windows which are after the paging in the modification period. When the indication in the Direct Indication information is default or is not configured, the UE 110 may perform a SIB accumulation across the SI windows before the Direct Indication information and after the Direct Indication information within the modification period. In addition, the indication is a new indication field in the Direct Indication information. The new filed may use spare bits in the Direct Indication information.

In an embodiment of the invention, in the accumulation method, the UE 110 may perform the accumulation over the SI windows which are before the paging in the modification period, in response to the indication corresponding to the first value, and perform the accumulation over the SI windows which are before the paging and the SI windows which are after the paging in the modification period, in response to the indication corresponding to the second value.

In an embodiment of the invention, in the accumulation method, the UE 110 may decode the system information blocks (SIBs) in the set of SI windows, wherein the SIB comprises updated information.

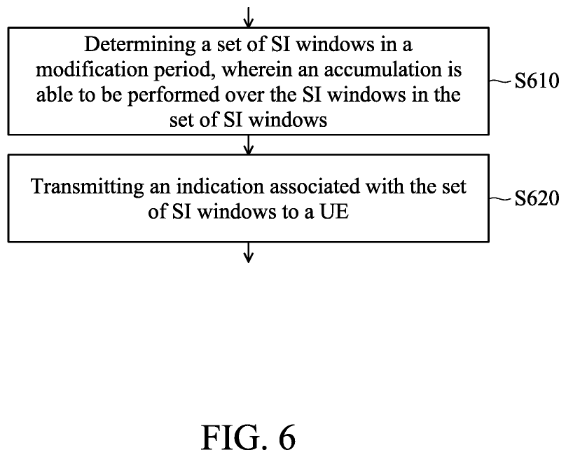

FIG. 6 is a flow chart illustrating an accumulation method for system information (SI) windows according to another embodiment of the invention. The accumulation method can be applied to the network node 120 of the wireless communications system. As shown in FIG. 6, in step S610, the network node 120 may determine a set of SI windows in a modification period, wherein an accumulation is able to be performed over the SI windows in the set of SI windows.

In step S620, the network node 120 may transmit an indication associated with the set of SI windows to the UE 110 through a system information block 1 (SIB1), a radio resource control (RRC) signaling or a paging.

In the accumulation method for SI windows provided in the invention, the UE may obtain the additional update information for the SIBs in a modification period from the network node. Therefore, in the accumulation method for SI windows provided in the invention, it can be ensured that the UE can decode SIBs within the SI windows of a modification period successfully when the parameters of SIB are updated in the same modification period.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An accumulation method for system information (SI) windows, comprising:
receiving, by a transceiver of an apparatus, an indication from a network node;
determining, by a processor of the apparatus, a set of SI windows in a modification period based on the indication; and
performing, by the processor, an accumulation over the SI windows in the set of SI windows.

2. The accumulation method for SI windows of claim 1, wherein the receiving of the indication further comprises:
receiving, by the transceiver, the indication through a system information block 1 (SIB1) or a radio resource control (RRC) signaling.

3. The accumulation method for SI windows of claim 2, wherein the indication comprising one bit, the method further comprises:
determining, by the processor, the number of the SI windows in the set of SI windows for enhanced machine-type communication (eMTC) based on a first default value and a periodicity of SI windows and determining, by the processor, the number of the SI windows in the set of SI windows for narrowband internet of things (NB-IoT) based on a second default value and the periodicity of the SI windows in response to the bit being a first value; and
determining, by the processor, the number of the SI windows in the set of SI windows for eMTC based on a third default value and the periodicity of the SI windows and determining, by the processor, the number of the SI windows in the set of SI windows for NB-IoT based on a fourth default value and the periodicity of the SI windows in response to the bit being a second value.

4. The accumulation method for SI windows of claim 2, wherein the indication comprising a plurality of bits, the method further comprises:
determining the number of the SI windows in the set of SI windows based on the plurality of bits and a mapping rule.

5. The accumulation method for SI windows of claim 4, wherein the mapping rule is determined based on a mapping table or a predefined equation, wherein the mapping table is configured or predefined.

6. The accumulation method for SI windows of claim 2, wherein the indication comprising a first set of bits and a second set of bits, the method further comprises:
determining the number of the SI windows in the set of SI windows based on the first set of bits; and
determining a start position of the set of SI windows in the modification period based on the second set of bits.

7. The accumulation method for SI windows of claim 2, further comprising:
determining a start position of the set of SI windows in the modification period based on a first window of the modification period.

8. The accumulation method for SI windows of claim 1, wherein the receiving of the indication further comprises:
receiving, by the transceiver, the indication through a paging, with a Direct Indication information.

9. The accumulation method for SI windows of claim 8, wherein the indication is a new indication field in the Direct Indication information, and the new indication field uses spare bits in the Direct Indication information which is transmitted on narrowband physical downlink control channel (NPDCCH) or Machine Type Communication (MTC) PDCCH (MPDCCH) through a paging radio network temporary identifier (P-RNTI).

10. The accumulation method for SI windows of claim 8, wherein the indication uses a bit to indicate a SI update information within the modification period.

11. The accumulation method for SI windows of claim 10, further comprising:
performing, by the processor, the accumulation over the SI windows which are before the paging in the modification period, in response to the bit corresponding to a first value; and
performing, by the processor, the accumulation over the SI windows which are before the paging and the SI windows which are after the paging in the modification period, in response to the bit corresponding to a second value.

12. The accumulation method for SI windows of claim 8, further comprising:
when the indication in the Direct Indication information is default or is not configured, performing a SIB accumulation across the SI windows before the Direct Indication information and after the Direct Indication information within the modification period.

13. The accumulation method for SI windows of claim 1, further comprising:
decoding, by the processor, one or more system information blocks (SIBs) in the set of SI windows, wherein the one or more SIBs comprises updated information.

14. An apparatus, comprising:
a transceiver, receiving an indication from a network node; and
a processor, coupled to the transceiver, determining a set of SI windows in a modification period based on the indication, and performing an accumulation over the SI windows in the set of SI windows.

15. The apparatus of claim 14, wherein
in response to the indication comprising one bit and the bit being a first value, the processor determines the number of the SI windows in the set of SI windows for enhanced machine-type communication (eMTC) based on a first default value and the periodicity of the SI windows and determines the number of the SI windows in the set of SI windows for narrowband internet of things (NB-IoT) based on a second default value and the periodicity of the SI windows, and
in response to the indication comprising one bit and the bit being a second value, the processor determines the number of the SI windows in the set of SI windows for eMTC based on a third default value and the periodicity of the SI windows and determines the number of the SI windows in the set of SI windows for NB-IoT based on a fourth default value and the periodicity of the SI windows.

16. The apparatus of claim 14, wherein the indication comprising a plurality of bits, the processor determines the number of the SI windows in the set of SI windows based on the plurality of bits and a mapping rule, and wherein the mapping rule is determined based on a mapping table or a predefined equation, wherein the mapping table is configured or predefined.

17. The apparatus of claim 14, wherein the indication comprising a first set of bits and a second set of bits, the processor determines the number of the SI windows in the set of SI windows based on the first set of bits and determines a start position of the set of SI windows in the modification period based on the second set of bits.

18. The apparatus of claim 14, wherein the transceiver receives the indication through a system information block 1 (SIB1) or a radio resource control (RRC) signaling ; or
receives the indication through a paging with a Direct Indication information and the indication uses a bit to indicate a SI update information within the modification period, and the processor is further configured to perform operations comprising:
in response to the indication corresponding to a first value, performs the accumulation over the SI windows which are before the paging and the SI windows which are after the paging in the modification period; or
in response to the indication corresponding to a second value or when the new indication field in the Direct Indication information is default or is not configured, performs the accumulation over the SI windows which are before the paging and the SI windows which are after the paging in the modification period.

19. The apparatus of claim 18, wherein the indication received through paging is a new indication field in the Direct Indication information.

20. An accumulation method for system information (SI) windows, comprising:
determining, by a network node, a set of SI windows in a modification period; and
transmitting, an indication associated with the set of SI windows to a user equipment (UE) through a system information block 1 (SIB 1), a radio resource control (RRC) signaling or a paging, wherein the user equipment performs an accumulation over the SI windows in the set of SI windows.
